(19) United States
(12) Patent Application Publication
(10) Pub. No.: US 2011/0175583 A1
(43) Pub. Date: Jul. 21, 2011

(54) High voltage regulated power supply

(76) Inventor: Clive Thomas, Moreleta Park (ZA)

(21) Appl. No.: 13/062,698

(22) PCT Filed: Sep. 8, 2009
(86) PCT No.: PCT/AU2009/001174

§ 371 Date: Mar. 8, 2011

(30) Foreign Application Priority Data
Sep. 11, 2008 (ZA) 2008/07840

(51) Int. Cl. G05F 1/575

(52) U.S. Cl. 323/280

(57) ABSTRACT

A regulated power supply circuit includes a voltage reference circuit arranged to generate a reference voltage and an output device responsive to a control signal to supply a load from a voltage source. A control circuit is arranged to compare an output voltage at the load with the reference voltage. The control circuit includes a comparator comprising a long-tailed transistor pair having a first input to which the reference voltage is applied, a second input to which the output voltage is applied, and an output connected to an input terminal of the output device. The control circuit applies a correction signal to the output device via a single semiconductor junction to regulate the output voltage, thereby minimising propagation delay in the control circuit. The circuit may include a primary voltage regulator arranged to supply the control circuit at a lower voltage than that of the voltage source.

### BACKGROUND OF THE INVENTION

THIS invention relates to a regulated power supply circuit which can be used, in particular, to supply a gain stage in an audio amplifier circuit.

Generally in high power audio amplifiers, high DC voltages are required for the gain stage and it is advisable that the power supply used is regulated. The load imposed on the power supply by such a gain stage can vary rapidly in terms of both amplitude and frequency. Conventionally, a regulated power supply based on an operational amplifier is used in such applications. However, regulators based on operational amplifiers generally have a limited ability to respond to rapidly varying loads, which can lead to highly undesirable instability and oscillation of the power supply.

It is an object of the present invention, to provide an alternative regulated power supply circuit.

### SUMMARY OF THE INVENTION

According to the invention there is provided a regulated power supply circuit comprising:
a voltage reference circuit arranged to generate a reference voltage;
an output device responsive to a control signal to supply a load from a voltage source; and
a control circuit arranged to compare an output voltage at the load with the reference voltage, the control circuit including a comparator comprising a long-tailed transistor pair having a first input to which the reference voltage is applied, a second input to which the output voltage is applied, and an output connected to an input terminal of the output device, the control circuit being arranged to apply a correction signal to the output device via a single semiconductor junction to regulate the output voltage, thereby to minimise propagation delay in the control circuit.

The regulated power supply circuit may include a primary voltage regulator arranged to supply the control circuit at a lower voltage than that of the voltage source.

The comparator may include a first current mirror arranged as an active current source.

The comparator may include a second current mirror arranged as an active current sink.

Preferably, the comparator includes both the first and second current mirrors, configured to enhance the gain and slew rate of the comparator.

The output device is preferably a power FET having a gate which is arranged to be driven by the correction signal of the control circuit.

### BRIEF DESCRIPTION OF THE DRAWINGS

FIG. 1 is a circuit diagram showing a prior art regulated power supply circuit;

FIG. 2 is a circuit diagram showing a regulated power supply circuit according to the present invention; and

FIGS. 3 to 8 are comparative plots of the behaviour of the output voltage of the prior power supply circuit of FIG. 1 and the regulated power supply circuit according to the present invention of FIG. 2, under a variety of test conditions.

### DESCRIPTION OF AN EMBODIMENT

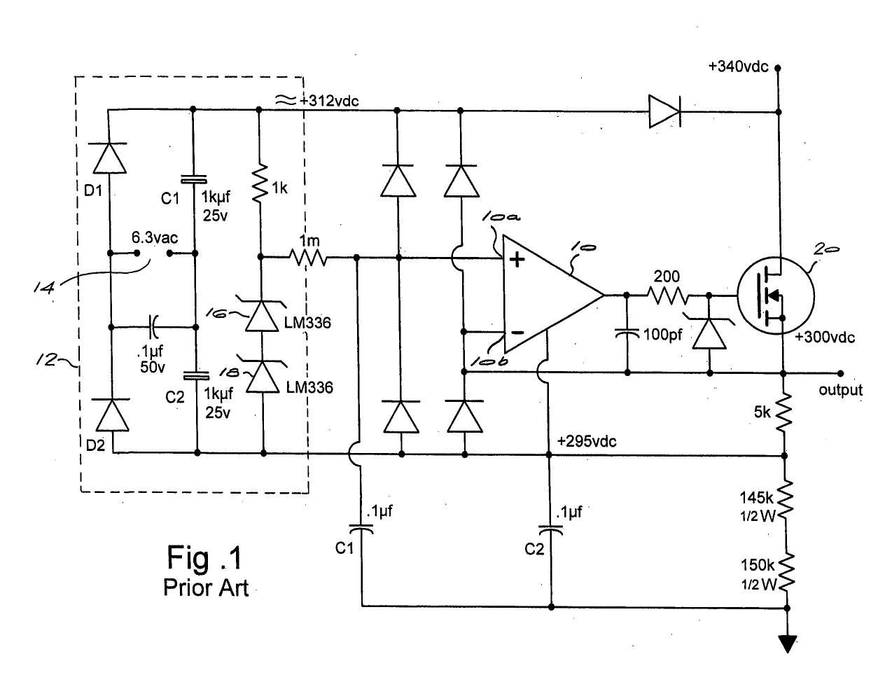

FIG. 1 is a circuit diagram showing a prior art regulated power supply circuit. The known regulated power supply circuit is based on an operational amplifier 10, configured as a comparator. The operational amplifier 10 has a non-inverting input 10a to which a reference voltage is applied and an inverting input 10b to which a feedback signal, derived from the voltage regulator output voltage, is applied.

The reference voltage is derived from a voltage reference circuit 12 comprising a 6.3V AC source 14, rectifying diodes D1 and D2 and smoothing capacitors C1 and C2. The voltage reference circuit further includes voltage reference diodes 16 and 18.

A correction signal is generated at the output of the operational amplifier 10, arising from differences between the reference voltage applied to the non-inverting input 10a and the feedback signal applied to the inverting input 10b, and is applied to the gate of a power FET 20.

The prior art circuit is satisfactory for use with static loads or loads which vary slowly. However, the use of an operational amplifier causes a relatively long propagation delay in the feedback loop of the circuit, meaning that its dynamic response is relatively slow. Accordingly, only modest rates of change of load condition can be supported. When the load varies instantaneously and rapidly, the long propagation delay and slow response rate of the comparator cause the output voltage to go into an undamped oscillation.

The prior art circuit proved unsuitable for supplying the gain stage in a high power audio amplifier, where it is desirable to provide a regulated supply at high voltage, particularly to gain stage circuits which do not exhibit an inherently high power supply ripple rejection ratio. Typical loads imposed on the power supply for such a gain stage vary rapidly over time as music signals of varying frequency and amplitude (presenting a pseudo-random load) are amplified by the gain stage. Such a power supply needs to remain stable under such rapidly varying dynamic load conditions.

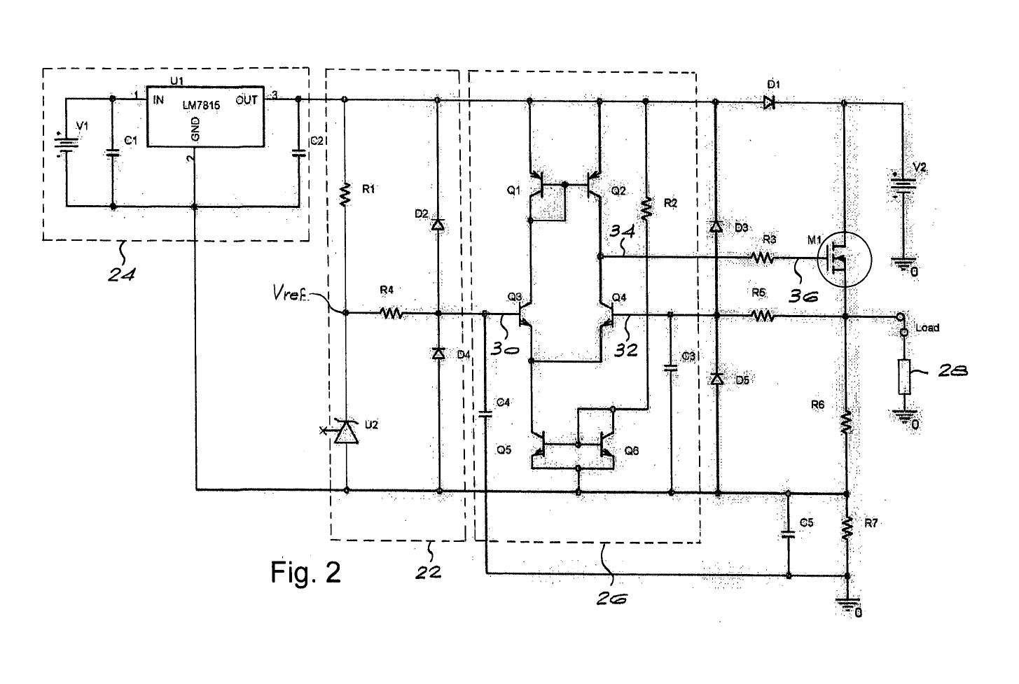

FIG. 2 is a circuit diagram showing an embodiment of a regulated power supply circuit according to the present invention. In FIG. 2, functional blocks have been superimposed on the circuit diagram for purposes of explanation. The circuit includes a voltage reference circuit 22 based on a voltage reference diode U2 and arranged to generate a stable reference voltage (Vref). The reference voltage in the prototype circuit was 5V but it will be appreciated that another suitable reference voltage could be selected, depending on the application of the regulated power supply circuit.

A primary voltage regulator circuit 24 is provided, which is based on a standard three-pin integrated circuit voltage regulator U1 and fed from a low voltage source V1 which is separate from a relatively high voltage source V2. The primary voltage regulator circuit supplies the voltage reference diode U2 via a current limiting resistor R1. The fact that the voltage reference diode U2 is operated from a regulated supply enhances its stability. The primary voltage regulator circuit 24 also supplies a control circuit 26, as described below.

The regulated power supply circuit includes an output device M1, typically a power FET, which is arranged to supply a load 28 from the high voltage source V2 in response to a control or correction signal.

A control circuit 26 is arranged to compare an output voltage at the load 28 with the reference voltage Vref. The control circuit 26 includes a comparator comprising a long-tailed pair of transistors Q3 and Q4, having a first, non-inverting input 30 to which the reference voltage Vref is applied, a second, inverting input 32 to which a feedback signal derived from the output voltage is applied, and an output 34 connected to an input terminal 36 of the output device (in the present example, to the gate of the power FET M1) via a current limiting resistor R3.

The first input 30 of the comparator is protected by clamp diodes D2 and D4 and via a current limiting resistor R4, while the second input 32 is protected by clamp diodes D3 and D5, and by a current limiting resistor R5.

The control circuit can include a first current mirror comprising transistors Q1 and Q2 arranged as an active current source for the comparator. The control circuit can also include a second current mirror comprising transistors Q5 and Q6 arranged as an active current sink.

In a preferred embodiment, as illustrated in FIG. 2, the control circuit includes both the first and second current mirrors Q1, Q2 and Q5, Q6, which serve to enhance the gain and slew rate of the comparator and increase its sensitivity and responsiveness.

The control circuit is supplied by the primary voltage regulator circuit 24. This is particularly useful in high voltage applications, as it allows high precision transistors, which are typically low voltage devices, to be used in the comparator of the control circuit. If high voltage operation is not required then the primary voltage regulator circuit can be omitted. It is evident that various types of integrated circuit regulator U1 can be used in the primary voltage regulator circuit. In the described embodiment, an LM7815 regulator was used for U1.

The feedback loop of the control circuit includes a reference load resistor R6, through which an appropriate current, say 1 mA, is always maintained. The current through the resistor R6 results in a potential or voltage across the resistor, which is chosen so that the voltage across the resistor R6 is equal to the reference voltage Vref. For example, where the reference voltage is 5V and the value for R6 would be derived as follows:

$$R = V \text{/} I$$

$$\begin{matrix}Therefore R = 5 V \text{/} 1 mA \\ = 5 k Ω\end{matrix}$$

This potential is connected to the second, inverting input 32 of the comparator, via a resistor R5. As mentioned above, the reference voltage Vref of 5V generated by the voltage reference circuit 22 is applied to the first, non-inverting input 30 of the comparator. The comparator thus generates a correction or comparison signal at its output 34, due to the difference between the reference voltage Vref and the voltage across R6, which is fed via the current limiting resistor R3 to the input terminal 36 of the output device (the power FET M1). Once these voltages are equal, the correction signal stabilizes at the correct value to drive the gate of the power FET M1 to exactly the correct level of current output.

A resistor R7 determines the output voltage of the power supply circuit. Depending on the reference current chosen and the value of the resistor R6, the final reference voltage with respect to absolute circuit ground is determined by the addition of R6 and R7 multiplied by the chosen current—for example, a reference voltage of 5V at U2 and a selected current of 1 mA through the resistor R6 would result in a value of 5 kΩ for R6. A value (for example) of 100 kΩ for R7 would result in a regulated output voltage of 105V, being the sum of R6 and R7 multiplied by 1 mA. Obviously, the unregulated voltage V2 of the main, unregulated power supply must be at least several volts higher than this value at maximum load current.

A capacitor C5 is used to avoid oscillation in the resistor R7. Due to typically high regulated voltages and the small current through this resistor, it is possible for the circuit to establish resonant oscillation under certain load conditions if this capacitor is omitted. The addition of this capacitor ensures stability of the potential across the resistor R7 by increasing the time constant of the resultant RC network. As the potential formed across the resistor R7 actually produces a pseudo-ground for the comparator circuit, it is essential that this capacitor be of high quality and moderately large—values of 47 μF or even higher may be necessary to establish a stable pseudo-ground.

A capacitor C4 is connected between the first, non-inverting input 30 of the comparator and ground, to ensure that the reference voltage Vref at the non-inverting input does not oscillate at high frequency. As this reference voltage is produced with respect to a pseudo-ground, which may undergo variation during load fluctuation, the addition of the capacitor C4 coupled to absolute ground at this point provides additional stability to the crucial voltage reference signal.

As shown in FIG. 2, the load 28 and the resistor R6 are in connected in parallel and are fed by the output device M1 from the high voltage unregulated supply V2. The effective current demand of the load is measured by current division between the load 28 and the resistor R6. When the load is stable, the currents in R6 and the load 28 are constant, and the circuit is in equilibrium.

If the load demand increases, this will momentarily divert more current into the load and result in lower current through the resistor R6, resulting in a drop of the voltage across R6. The voltage applied to the second input 32 of the comparator will drop, causing the correction (comparison) signal to rise in value. This increase in the correction signal will increase the gate potential of the power FET M1, which will cause the current output by this device to rise. The current output resulting from this feedback loop will rise until the increase in load demand has been met, and the spillover current through the resistor R6 returns to the required level. At this point the feedback circuit stabilises and the entire circuit remains in equilibrium until the load demand changes again.

If the load demand decreases, less current will be diverted to the load while more current will pass through the resistor R6. This will cause the potential across the resistor R6 to rise, and the signal into the second input 32 of the comparator will rise accordingly. The correction or comparison signal output from the comparator will decrease, thereby decreasing the gate signal to the power FET M1. This will decrease the current output from power FET until the current through the resistor R6 has once again fallen to a level which results in the required potential across this resistor, at which point the feedback circuit once again stabilises.

Compared with the prior art voltage regulator circuit, which has a generally similar topology to that of the embodiment of the present invention shown in FIG. 2, the circuit of the invention has greatly improved performance when supplying dynamically varying loads. This is due in particular to the use of an optimised long-tail pair of high-gain matched discrete transistors as a comparator with two important features. Firstly, the addition of source and sink current mirrors to the long-tail pair increases the gain and slew rate of the comparator to provide the speed of reaction required when the load condition changes. Secondly, the fact that the feedback circuit includes only a single semiconductor junction (being the junction of the transistor Q4) means that the propagation delay in the feedback circuit is an absolute minimum for an active circuit.

Compared with the prior art circuit of FIG. 1, the regulated power supply circuit of the present invention has only a single semiconductor junction in the circuit between the feedback signal and the correction signal. This results in a propagation delay 10 times less (or even better) than that characteristic of an operational amplifier. As a result, significantly faster rates of change in the load current can be absorbed before oscillation occurs.

Many operational amplifier circuits use a long-tail pair as the differential amplification circuit at their input. However, in all operational amplifiers this circuit is followed by additional circuitry to provide additional functionality such as circuit protection or additional gain. The use of a long-tail pair stage as a sole comparator mechanism, with no additional circuits or components (and hence no additional junctions) in the signal path, allows the most rapid reaction to changes in load.

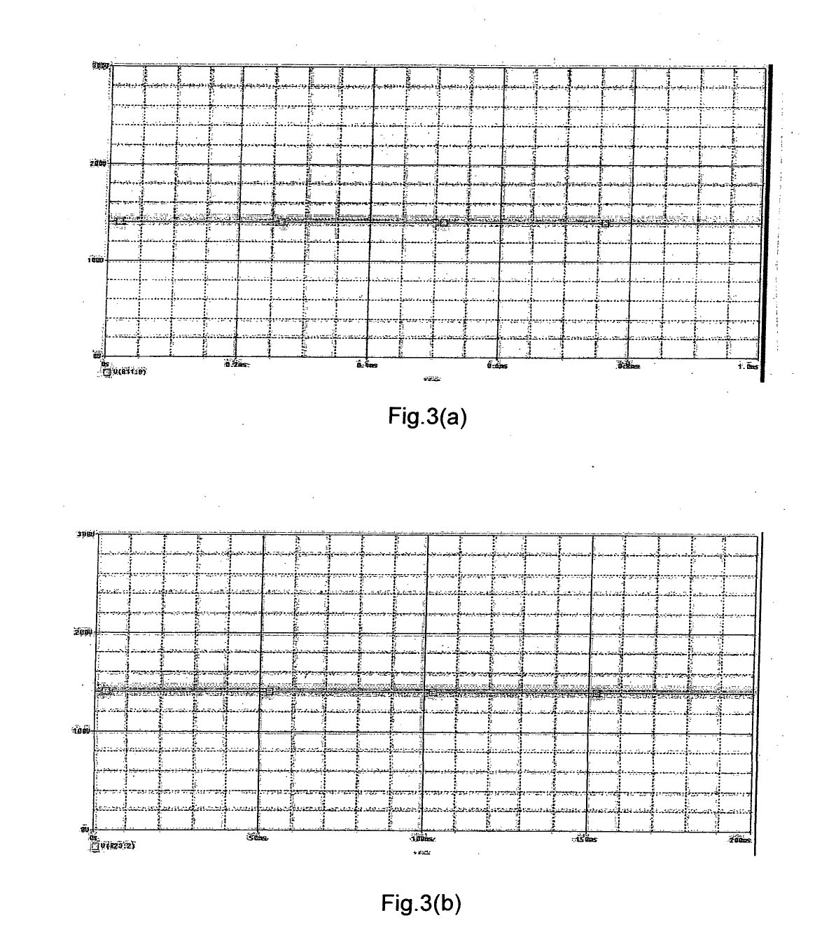

The performance of the prior art regulated power supply circuit and that of the present invention are compared in the plots of FIGS. 3 to 8.

FIGS. 3a and 3b are plots of the behaviour of the output voltage using the prior art power supply circuit and the regulated power supply circuit according to the present invention, with a static load. It can be seen that in a static load condition both the prior art and new circuits perform well. In this test scenario the conditions were the following:
Unregulated voltage source=180V
Static load coupled to the output: 5.1 kΩ, equivalent to 4 W load
Regulated output set to=140V
Dynamic Load=0

In order to establish the essential difference between the two circuits, a minimal load scenario was determined in which the prior art circuit fails to remain stable. Predictably, this results when a dynamic load is added to the total load, and especially when the frequency of change of the dynamic load exceeds a given frequency.

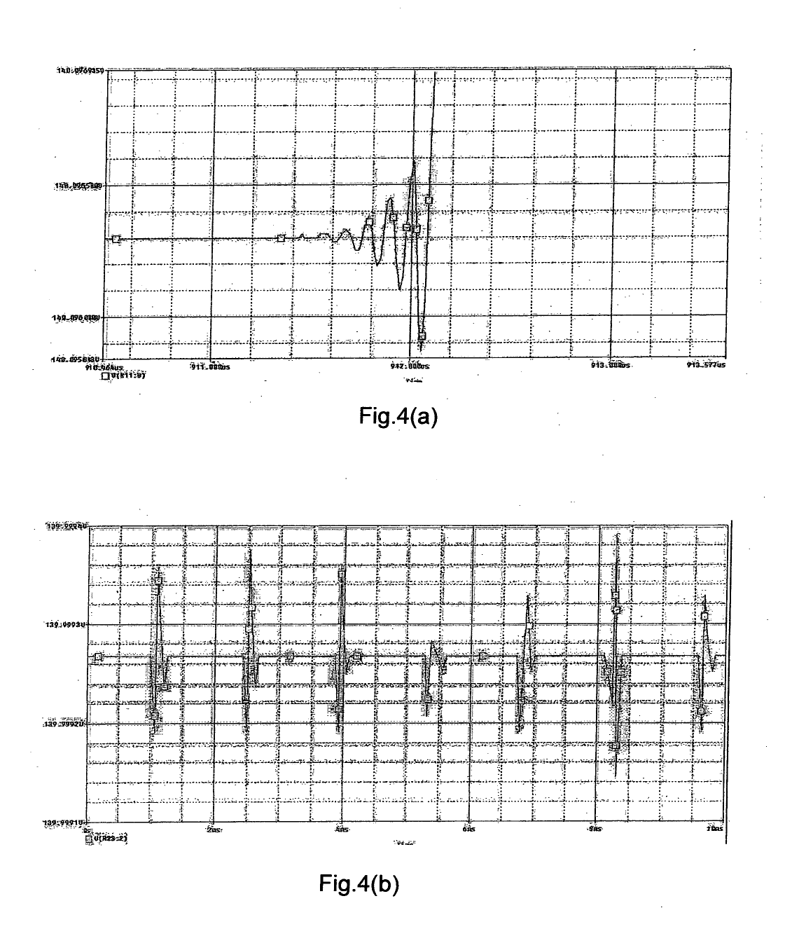

FIGS. 4a and 4b show the behaviour of the two circuits with a dynamic load varying from 0 W to 3 W, 700 times per second.

It is clear from FIG. 4a that the prior art circuit fails to remain stable. Experimentation showed that the prior art circuit performed reasonably well at frequencies of less than 600 Hz. However, given the above load, the prior art circuit becomes unstable and fails after less than 1 ms. The circuit of the present invention shows a ripple of the order of 2 mV which is acceptable in an audio circuit.

In this test scenario the conditions were the following:
Unregulated voltage source=180V
Static load coupled to the output: 5.1 kΩ, equivalent to 4 W load
Regulated output set to=140V
Dynamic Load=varying from 0 W to 3 W, 700 times per second

To test the extent of the enhanced stability under load for the circuit of the invention, an extreme load scenario was established. The load specified is beyond that imposed by any normal audio gain stage, and therefore clearly establishes stability in normal operation with respect to highly dynamic loads. The following test conditions were used:
Unregulated voltage source=180V
Regulated output set to 140V
Static load coupled to output: 1 kΩ, equivalent to a 19.6 W load
Dynamic load coupled to output: Varying from 0 W to 160 W, 1000 times per second

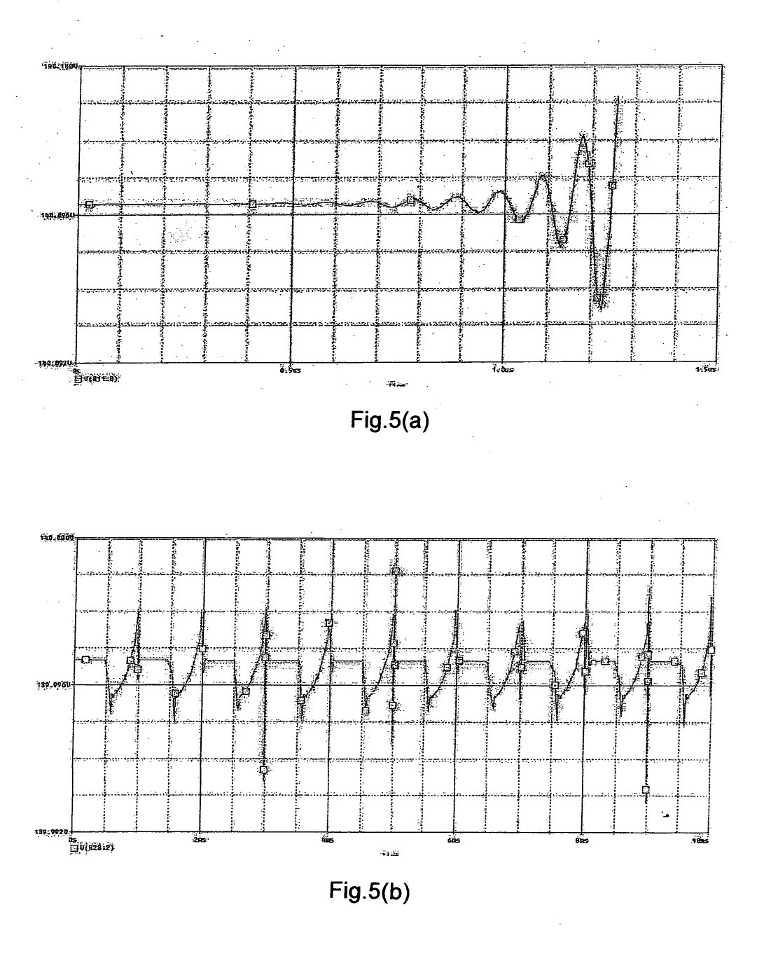

As can be seen in FIG. 5a, the prior art circuit goes unstable and fails after approximately 0.1 ms, in other words it fails immediately. The circuit of the invention, as shown in FIG. 5b, exhibits complete stability over any period, with ripple of approximately 6 mV worst case—surprisingly low considering the load imposed.

To test the extent of the enhanced stability of the circuit of the invention under a high frequency load, first a load (slightly higher than normally found) was imposed at high frequency. Although this load is very high for this frequency, it would be possible under extreme circumstances to encounter such a load scenario, and the regulator should be able to handle this. The test conditions were:
Unregulated voltage source=180V
Regulated output set to 140V
Static load coupled to output: 1 kΩ, equivalent to a 19.6 W load
Dynamic load coupled to output: Varying from 0 W to 3 W, 20 000 times per second

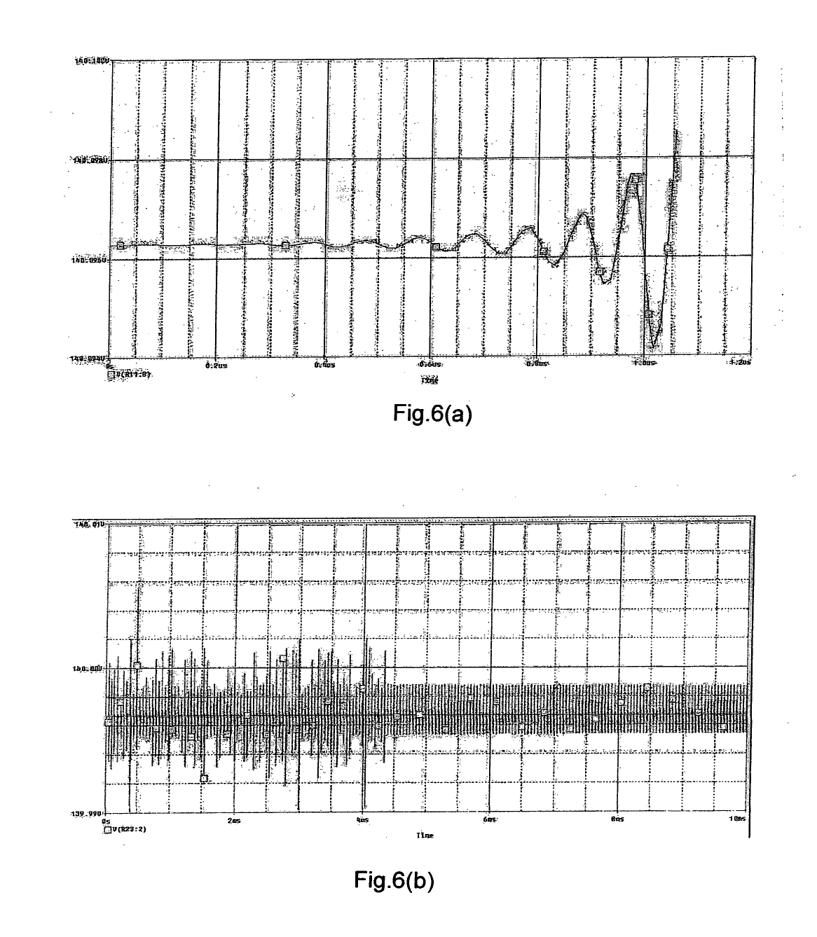

As can be seen from FIG. 6a, the prior art circuit again fails within approximately 0.1 mS. The circuit of the invention, by way of contrast, shows improved stability after start-up, and after approximately 4 ms establishes a steady ripple of approximately 40 mV—this is larger than desirable but given the extreme nature of the load as compared with real-world scenarios in an audio amplifier this is acceptable. Most importantly, the power supply remains stable.

In a further scenario to test the extent of stability under extreme conditions including both a high frequency and a large dynamic load, a dynamic 160 W load was imposed at 20 kHz. This load completely surpasses a normal load imposed by an audio amplifier gain stages and is used solely to illustrate the comparative stability of the prior art and new circuits. The test conditions were as follows:
Unregulated voltage source=180V
Regulated output set to 140V
Static load coupled to output: 1 kΩ, equivalent to a 19.6 W load
Dynamic load coupled to output: Varying from 0 W to 160 W, 20 000 times per second

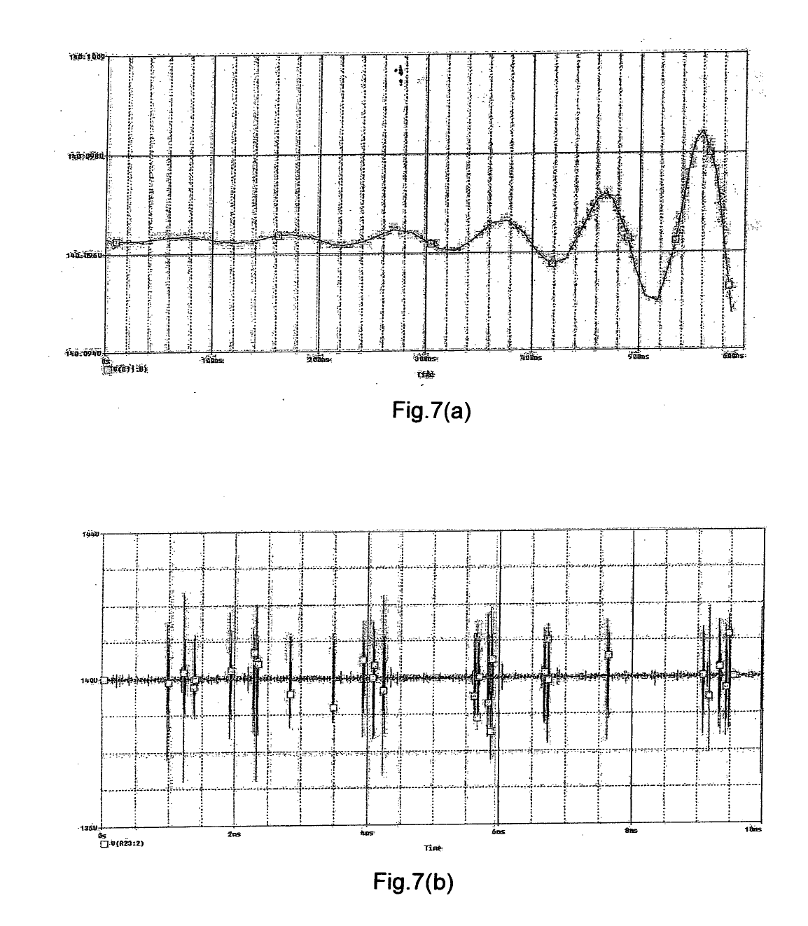

As seen in FIG. 7a, the original circuit fails with no hint of stability even at the very onset of operation. The circuit fails completely within 600 ns. The circuit of the present invention—understandably given the extreme nature of the load—shows high ripple (approximately 4V) but remains stable, as shown in FIG. 7b.

A final test demonstrates the scale of the enhancement provided by the circuit of the invention with respect to dynamic loads. A modest and very representative dynamic load at high frequency, which is certainly characteristic of loads to be found in a gain stage of an audio amplifier, is coupled to the power supply circuit with the following conditions:
Unregulated voltage source=180V
Regulated output set to 140V
Static load coupled to output: 5.1 kΩ, equivalent to a 2 W load
Dynamic load coupled to output: Varying from 0 W to 0.33 W, 20 000 times per second

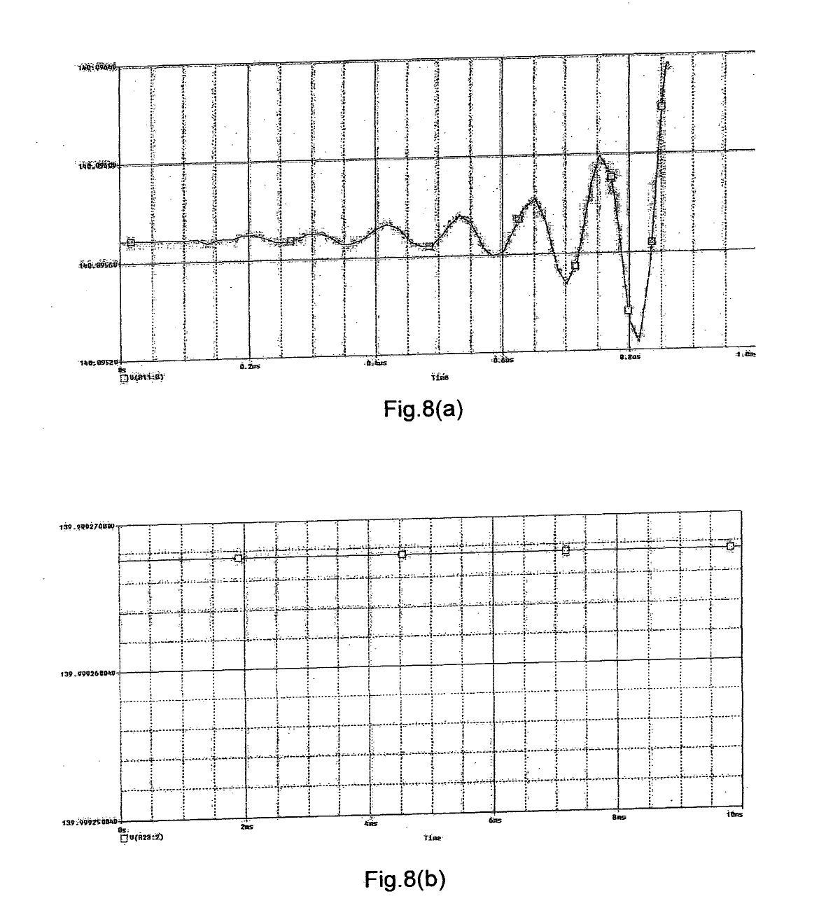

Again the original circuit fails in less than 0.1 mS, despite a very modest dynamic load, as shown in FIG. 8a. As can be seen from FIG. 8b, the circuit of the invention shows perfect stability with extremely low ripple.

As can be predicted from the slow propagation delay of an operational amplifier, dynamic loads cause the prior art circuit to oscillate and fail where the rate of change of the load exceeds the ability of the operational amplifier to react to the change and provide a correction signal to the power FET. Regardless of the operational amplifier chosen, this propagation delay will be multiple times longer than that for a single semiconductor junction, as the typical design for an operational amplifier will often include ten or more semiconductor junctions in the total path between the inverting input and the output of the device.

By contrast, the circuit of the present invention will, as a result of having the lowest possible semiconductor junction count in the feedback path, respond in the quickest time possible for a feedback circuit. As a result, stability under dynamic loads is vastly improved, and under most real-world conditions in an audio gain stage the output voltage has very low ripple.

It should be noted that in a real-world gain-stage application, the prior art power supply circuit will seldom fail completely. In the majority of situations, due to the varying nature of the audio signal, the circuit will merely burst into oscillation temporarily and then revert to stability as the amplitude of the audio signal decreases. This oscillation will manifest as significantly higher overall distortion during and immediately after such high amplitude passages. Under the same conditions the circuit of the present invention remains completely stable, resulting in significantly lower audio distortion.

The regulated power supply circuit of the invention has a number of advantageous features. It should be noted that although some of the advantages listed below are also true for the prior art circuit, the failure of the prior art circuit under real-world conditions renders those attributes valueless in that circuit.

No Output Capacitor Required

The circuit requires no capacitance at the output, as the load is regulated through current control and therefore capacitance placed on the output of the regulator actually worsens the effective regulation of the circuit. In a high voltage application, this is a significant advantage as high voltage capacitors are typically large and expensive.

Extremely Good Regulation for Static Loads

Under conditions with low dynamic load, the regulation of the circuit is very good—this is important in audio circuits where low dynamic load represents quiet passages in the music, under which conditions power supply noise will typically be audible in the form of hiss (white noise) emanating from the speakers.

Very Good Stability Under Dynamic Loads

Due to the fast response of the comparator circuit, the regulator is stable under a very wide range of dynamic loads. This prevents audible oscillation (representing power supply ripple) or circuit failure under demanding conditions with high amplitude signals.

Usable in High-Power Audio Gain Stages

Several attractive gain stage topologies have poor power supply ripple rejection, which implies the requirement of a regulated power supply. In high power amplifiers, the power supply voltage required could be 200V or more in order to provide the voltages required to drive a 4 or 8 ohm speaker to high amplitude. The nature and characteristics of the described power supply circuit allow it to be used with such gain stages in an audio application.

Highly Configurable Output Voltage

As the output voltage is determined solely by the value of the resistor R7 and the reference voltage presented by the voltage reference device U2, it is possible to provide output voltages ranging from about 3V to more than 500V with virtually no other component changes.

High Current Capability

Provided that an appropriate power FET (M1) is selected, it is possible to provide current of 5 A or more to the load. In cases where even more current is demanded, it is possible to parallel two or more output FETs in order to supply currents of 10 A or more. In these cases, and especially where the voltage differential between the unregulated high voltage supply and the output voltage is large, a suitable heat sink will be required for the FET.

No High-Wattage Passive Components

As all the currents in the circuit are very small (with the exception of the current through the power FET) none of the resistors in the circuit requires more than ¼ W dissipation.

Low Heat Dissipation

In a typical audio application where the required power levels are in the region of 3 W to 10 W, the total heat dissipated by the circuit is very low, and in most applications the power FET will not even require a heat sink.

What is claimed is:

1. A regulated power supply circuit comprising:
a voltage reference circuit arranged to generate a reference voltage;
an output device responsive to a control signal to supply a load from a voltage source; and
a control circuit arranged to compare an output voltage at the load with the reference voltage, the control circuit including a comparator comprising a long-tailed transistor pair having a first input to which the reference voltage is applied, a second input to which the output voltage is applied, and an output connected to an input terminal of the output device, the control circuit being arranged to apply a correction signal to the output device via a single semiconductor junction to regulate the output voltage, thereby to minimise propagation delay in the control circuit.

2. A regulated power supply circuit according to claim 1 wherein the regulated power supply circuit includes a primary voltage regulator arranged to supply the control circuit at a lower voltage than that of the voltage source.

3. A regulated power supply circuit according to claim 1 wherein the comparator includes a first current mirror arranged as an active current source.

4. A regulated power supply circuit according to claim 3 wherein the comparator includes a second current mirror arranged as an active current sink.

5. A regulated power supply circuit according to claim 4 wherein the comparator includes both the first and second current mirrors, configured to enhance the gain and slew rate of the comparator.

6. A regulated power supply circuit according to claim 1 wherein the output device is a power FET having a gate which is arranged to be driven by the correction signal of the control circuit.
